(19) United States
(12) Patent Application Publication
(10) Pub. No.: US 2023/0067808 A1
(43) Pub. Date: Mar. 2, 2023

(54) FEEDBACK GENERATION FOR LINK ADAPTATION

(71) Applicant: Samsung Electronics Co., Ltd., Suwon-si (KR)

(72) Inventors: Ruchen Duan, Santa Clara, CA (US); Wook Bong Lee, San Jose, CA (US); Vamadevan Namboodiri, San Jose, CA (US); Srinivas Kandala, Morgan Hill, CA (US); Ashok Ranganath, San Jose, CA (US)

(21) Appl. No.: 17/883,528

(22) Filed: Aug. 8, 2022

Related U.S. Application Data
(60) Provisional application No. 63/237,989, filed on Aug. 27, 2021.

(51) Int. Cl. H04L 1/00; H04L 1/20

(52) U.S. Cl. CPC H04L 1/0003; H04L 1/203

(57) ABSTRACT

A system and method for feedback for link adaptation. In some embodiments, the method includes: receiving, by a receiver, a first transmission from a transmitter; calculating a first estimated packet error rate, for a first modulation and coding scheme and a first number of spatial streams, the first modulation and coding scheme having a first modulation and coding scheme index; determining that the first estimated packet error rate is less than a threshold; and in response to determining that the first estimated packet error rate is less than the threshold, calculating a second estimated packet error rate, for a second modulation and coding scheme.

### CROSS-REFERENCE TO RELATED APPLICATION(S)

The present application claims priority to and the benefit of U.S. Provisional Application No. 63/237,989, filed Aug. 27, 2021, entitled “ENHANCED FEEDBACK PROCEDURE IN WLAN SYSTEM”, the entire content of which is incorporated herein by reference.

### FIELD

One or more aspects of embodiments according to the present disclosure relate to wireless communications, and more particularly to a system and method for feedback for link adaptation.

### BACKGROUND

In a wireless communication system, a transmitter may send data to a receiver. The transmission parameters used by the transmitter may be based in part on feedback it receives from the receiver, which may include suggested transmission parameters.

It is with respect to this general technical environment that aspects of the present disclosure are related.

### SUMMARY

According to an embodiment of the present disclosure, there is provided a method, including: receiving, by a receiver, a first transmission from a transmitter; calculating a first estimated packet error rate, for a first modulation and coding scheme and a first number of spatial streams, the first modulation and coding scheme having a first modulation and coding scheme index; determining that the first estimated packet error rate is less than a threshold; and in response to determining that the first estimated packet error rate is less than the threshold, calculating a second estimated packet error rate, for a second modulation and coding scheme.

In some embodiments, the calculating of the second estimated packet error rate includes further calculating the second estimated packet error rate for the first number of spatial streams.

In some embodiments, the second modulation and coding scheme has a second modulation and coding scheme index, the second modulation and coding scheme index being greater, by one, than the first modulation and coding scheme index.

In some embodiments, the method further includes calculating a first estimated throughput, for the first modulation and coding scheme and the first number of spatial streams.

In some embodiments, the first transmission is a transmission made using the first modulation and coding scheme and the first number of spatial streams.

In some embodiments, the method further includes: determining that the second estimated packet error rate is less than the threshold; and, in response to determining that the second estimated packet error rate is less than the threshold, calculating a second estimated throughput, for the second modulation and coding scheme and the first number of spatial streams.

In some embodiments, the method further includes: determining that the second estimated throughput is greater than the first estimated throughput; and in response to determining that the second estimated throughput is greater than the first estimated throughput, sending, by the receiver, to the transmitter, the second modulation and coding scheme as a suggested modulation and coding scheme.

In some embodiments, the method further includes: determining that the second estimated packet error rate is greater than the threshold; and in response to determining that the second estimated packet error rate is greater than the threshold, calculating a third estimated packet error rate for a third modulation and coding scheme and the first number of spatial streams, the third modulation and coding scheme having a third modulation and coding scheme index, the third modulation and coding scheme index being less, by one, than the first modulation and coding scheme index.

In some embodiments, the calculating of the first estimated throughput includes calculating the first estimated throughput based on an assumption about a degradation in channel quality due to aging of channel state information.

In some embodiments, the method further includes: receiving, by the receiver, a second transmission from the transmitter, the second transmission using a third modulation and coding scheme and the first number of spatial streams, the third modulation and coding scheme having a third modulation and coding scheme index; calculating a third estimated packet error rate, for the third modulation and coding scheme and the first number of spatial streams; determining that the third estimated packet error rate is greater than the threshold; and in response to determining that the third estimated packet error rate is greater than the threshold, calculating a fourth estimated packet error rate, for a fourth modulation and coding scheme and the first number of spatial streams, the fourth modulation and coding scheme having a fourth modulation and coding scheme index, the fourth modulation and coding scheme index being less, by one, than the third modulation and coding scheme index.

In some embodiments, the method further includes: receiving, by the receiver, a second transmission from the transmitter; making a determination that, for each of the first transmission and the second transmission: the number of spatial streams is less than the maximum supported number of spatial streams, the modulation and coding scheme is the maximum supported modulation and coding scheme, and the packet error rate is less than the threshold; and in response to making the determination, sending, by the receiver, to the transmitter, a second number of spatial streams, higher than the first number of spatial streams, as a suggested number of spatial streams.

In some embodiments, the method further includes: receiving, by the receiver, a second transmission from the transmitter; determining that, for each of the first transmission and the second transmission, the packet error rate is greater than the threshold; and in response to determining that, for each of the first transmission and the second transmission, the packet error rate is greater than the threshold, sending, by the receiver, to the transmitter, a third modulation and coding scheme as a suggested modulation and coding scheme, the third modulation and coding scheme having an index less than the first modulation and coding scheme index.

According to an embodiment of the present disclosure, there is provided a system, including: a processing circuit; and memory, operatively connected to the processing circuit and storing instructions that, when executed by the processing circuit, cause the system to perform a method, the method including: receiving a first transmission from a transmitter; calculating a first estimated packet error rate, for a first modulation and coding scheme and a first number of spatial streams, the first modulation and coding scheme having a first modulation and coding scheme index; determining that the first estimated packet error rate is less than a threshold; and in response to determining that the first estimated packet error rate is less than the threshold, calculating a second estimated packet error rate, for a second modulation and coding scheme.

In some embodiments: the calculating of the second estimated packet error rate includes further calculating the second estimated packet error rate for the first number of spatial streams; and the second modulation and coding scheme has a second modulation and coding scheme index, the second modulation and coding scheme index being greater, by one, than the first modulation and coding scheme index.

In some embodiments, the method further includes calculating a first estimated throughput, for the first modulation and coding scheme and the first number of spatial streams.

In some embodiments, the first transmission is a transmission made using the first modulation and coding scheme and the first number of spatial streams.

In some embodiments, the method further includes: determining that the second estimated packet error rate is less than the threshold; and, in response to determining that the second estimated packet error rate is less than the threshold, calculating a second estimated throughput, for the second modulation and coding scheme and the first number of spatial streams.

In some embodiments, the method further includes: determining that the second estimated throughput is greater than the first estimated throughput; and in response to determining that the second estimated throughput is greater than the first estimated throughput, sending, to the transmitter, the second modulation and coding scheme as a suggested modulation and coding scheme.

In some embodiments, the method further includes: determining that the second estimated packet error rate is greater than the threshold; and in response to determining that the second estimated packet error rate is greater than the threshold, calculating a third estimated packet error rate for a third modulation and coding scheme and the first number of spatial streams, the third modulation and coding scheme having a third modulation and coding scheme index, the third modulation and coding scheme index being less, by one, than the first modulation and coding scheme index.

In some embodiments, the method further includes: receiving a second transmission from the transmitter, the second transmission using a third modulation and coding scheme and the first number of spatial streams, the third modulation and coding scheme having a third modulation and coding scheme index; calculating a third estimated packet error rate, for the third modulation and coding scheme and the first number of spatial streams; determining that the third estimated packet error rate is greater than the threshold; and in response to determining that the third estimated packet error rate is greater than the threshold, calculating a fourth estimated packet error rate, for a fourth modulation and coding scheme and the first number of spatial streams, the fourth modulation and coding scheme having a fourth modulation and coding scheme index, the fourth modulation and coding scheme index being less, by one, than the third modulation and coding scheme index.

In some embodiments, the method further includes: receiving a second transmission from the transmitter; making a determination that, for each of the first transmission and the second transmission: the number of spatial streams is less than the maximum supported number of spatial streams, the modulation and coding scheme is the maximum supported modulation and coding scheme, and the packet error rate is less than the threshold; and in response to making the determination, sending, to the transmitter, a second number of spatial streams, higher than the first number of spatial streams, as a suggested number of spatial streams.

In some embodiments, the method further includes: receiving a second transmission from the transmitter; determining that, for each of the first transmission and the second transmission, the packet error rate is greater than the threshold; and in response to determining that, for each of the first transmission and the second transmission, the packet error rate is greater than the threshold, sending, to the transmitter, a third modulation and coding scheme as a suggested modulation and coding scheme, the third modulation and coding scheme having an index less than the first modulation and coding scheme index.

According to an embodiment of the present disclosure, there is provided a system, including: means for processing; and memory, operatively connected to the means for processing and storing instructions that, when executed by the means for processing, cause the system to perform a method, the method including: receiving a first transmission from a transmitter; calculating a first estimated packet error rate, for a first modulation and coding scheme and a first number of spatial streams, the first modulation and coding scheme having a first modulation and coding scheme index; determining that the first estimated packet error rate is less than a threshold; and in response to determining that the first estimated packet error rate is less than the threshold, calculating a second estimated packet error rate, for a second modulation and coding scheme and the first number of spatial streams.

### BRIEF DESCRIPTION OF THE DRAWINGS

These and other features and advantages of the present disclosure will be appreciated and understood with reference to the specification, claims, and appended drawings wherein:

FIG. 1 is a timing diagram of wireless communications, according to an embodiment of the present disclosure;

FIG. 2 is a flow chart of a method, according to an embodiment of the present disclosure; and

FIG. 3 is block diagram of a portion of a wireless system, according to an embodiment of the present disclosure.

### DETAILED DESCRIPTION

The detailed description set forth below in connection with the appended drawings is intended as a description of exemplary embodiments of a system and method for link adaptation provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

In a wireless communication system (e.g., a Wi-Fi system), wireless transmissions may be made between transceivers, with each transceiver including a transmitter and a receiver. For example, in a Wi-Fi system, a first transceiver may be part of an Access Point Station (AP-STA) and a second transceiver may be part of a non-Access Point Station (non-AP-STA). When a packet (e.g., an ethernet frame) is sent from the AP-STA to the non-AP-STA, the AP-STA may operate as the transmitter and the non-AP-STA may operate as the receiver; when a packet is sent from the non-AP-STA to the AP-STA, the non-AP-STA may operate as the transmitter and the AP-STA may operate as the receiver.

For such transmissions, various transmission parameters may be set or adjusted, including a modulation and coding scheme (MCS) (which may be identified by a modulation and coding scheme index (MCS index)), and a number of spatial streams (NSS). An increase in modulation and coding scheme (a change in modulation and coding scheme that results in an increase in the modulation and coding scheme index) generally may result in a larger number of bits per symbol being transmitted, and may also result in a higher packet error rate (PER).

Link adaptation may be employed to set such transmission parameters. During the link adaptation process, a transmitter selects the modulation and coding scheme and the number of spatial streams, with the goal of achieving acceptable (e.g., of optimizing) throughput. Feedback (which may be referred to as “link adaptation feedback” (LAFB)) from the receiver may be used to convey channel quality information to the transmitter.

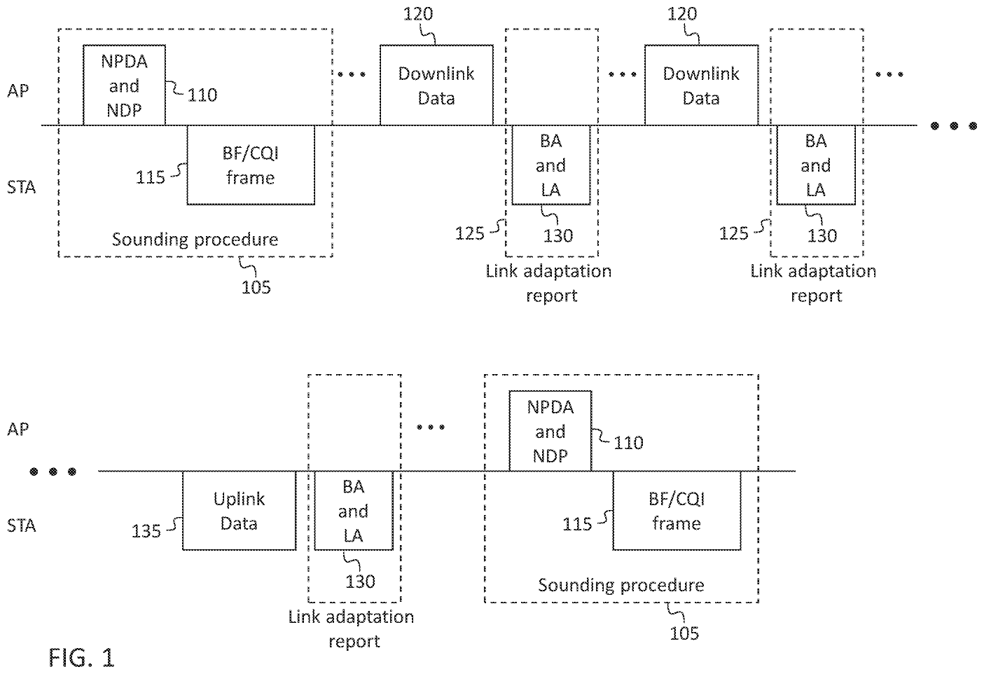

FIG. 1 shows communications that may be exchanged between a transmitter and a receiver (e.g., between an Access Point Station (AP) and a non-Access Point Station (STA)). During the sounding procedure 105, the transmitter (which, in the context of beamforming, may be referred to as the beamformer) may send, to the receiver (which, in the context of beamforming, may be referred to as the beamformee), a transmission 110 including a null data packet announcement (NDPA) and a null data packet (NDP), and the receiver may send, to the transmitter, a Beam Forming (BF)/Channel Quality Information (CQI) frame 115. The transmitter may then send, to the receiver, one or more beamformed data transmissions 120, after some or all of which the receiver may send, to the transmitter, a link adaptation report 125, or “link adaptation feedback frame (LAFB)” including a transmission 130 that includes Block Acknowledgement (Block ACK, or BA) and link adaptation feedback (LA) information. In some embodiments, the BA is sent after data is received. The link adaptation information may be attached to each or some of the BAs. The receiver may also, on occasion, send an uplink data transmission 135 to the transmitter. In this process, the link adaptation feedback frame 125 may provide more frequent and accurate feedback (than the Beam Forming (BF)/Channel Quality Information (CQI) frame 115), enabling the transmitter to select transmission parameters that result in improved (e.g., acceptable and optimal) system throughput.

As used herein, “Channel Quality Information (CQI)” refers to various kinds of information that the receiver may send to the transmitter as part of link adaptation feedback, including information sent in the Channel Quality Information frame, and information sent in the link adaptation report 125. Channel Quality Information may have various forms including, but not limited to, signal to noise ratio (SNR) and suggested transmission parameters (e.g., a suggested modulation and coding scheme or a suggested number of spatial streams).

In some embodiments, the receiver generates suggestions for transmission parameters (e.g., a suggested modulation and coding scheme or a suggested number of spatial streams), to be sent to the transmitter, by (i) deriving per subcarrier SNR for each number of spatial streams, (ii) calculating an effective SNR for each modulation and coding scheme candidate for each number of spatial streams, (iii) selecting the modulation and coding scheme and number of spatial streams combination that provides the maximum throughput.

The generation of suggestions for transmission parameters, e.g., for the modulation and coding scheme and for the number of spatial streams, may use several methods to generate reliable suggestions without unduly burdening the receiver, as discussed in further detail below. When the beamforming feedback channel state information (CSI) is updated only during the sounding procedure, it may become aged over time. As such, the receiver may apply an offset, after deriving the per subcarrier SNR, to produce an adjusted per subcarrier SNR, which includes an estimate of the degradation in SNR resulting from the degradation in channel quality due to the aging of the channel state information. Throughput estimates may then be made based on an assumption about a degradation in channel quality due to aging of channel state information.

Calculating the effective SNR for each candidate modulation and coding scheme may be time-consuming and power-consuming. To mitigate this consumption of resources, a specific order for evaluating candidate modulation and coding schemes may be used, for each candidate number of spatial streams. In some embodiments, the calculation begins with the most recently transmitted modulation and coding scheme. If the estimated packet error rate (PER) exceeds a threshold (e.g., a maximum acceptable packet error rate, which may be between 1% and 50%, e.g., 10%), the calculation (of the estimated packet error rate) is repeated for the next lower modulation and coding scheme (the modulation and coding scheme having the next lower modulation and coding scheme index). If, instead, the estimated packet error rate for the most recently transmitted modulation and coding scheme is less than the threshold, then (e.g., in response to determining that the estimated packet error rate for the most recently transmitted modulation and coding scheme is less than the threshold) the receiver may calculate the estimated packet error rate for the next higher modulation and coding scheme. The receiver may continue testing higher modulation and coding schemes until the estimated packet error rate exceeds the threshold or (as discussed below) until the estimated throughput begins to decrease with increasing modulation and coding scheme.

Using this approach, the receiver may keep as candidates only modulation and coding schemes for which the estimated packet error rate is less than the threshold. The receiver may estimate the throughput for each such candidate modulation and coding scheme, increasing or decreasing the modulation and coding scheme until the throughput begins to decrease (with increasing or decreasing modulation and coding scheme index). Once this process has been completed for each candidate value of the number of spatial streams, the receiver may identify, as the highest-throughput combination, the combination of the modulation and coding scheme and the number of spatial streams for which the estimated throughput is greatest and the packet error rate is less than the threshold. The receiver may then send, to the transmitter, as a suggested modulation and coding scheme, and as a suggested number of spatial streams, the modulation and coding scheme and the number of spatial streams of the highest-throughput combination.

In some embodiments, the receiver estimates the throughput for a combination of a modulation and coding scheme and a number of spatial streams only after determining that the packet error rate is below the threshold for the combination. In some embodiments, the receiver estimates both the throughput and the packet error rate for a combination of a modulation and coding scheme and a number of spatial streams, and then eliminates the combination from the set of candidates if the packet error rate is greater than the threshold.

In some embodiments, when the packet error rates for a number (e.g., for a number between 2 and 100, e.g., 5) of consecutive previous transmissions have each exceeded the threshold, the receiver may use a suggested modulation and coding scheme and a suggested number of spatial streams, one or both of which are lower than the ones used for the most recent transmission, without estimating the throughput for the currently used modulation and coding scheme and number of spatial streams, or even if the receiver estimates that the most recently used modulation and coding scheme and number of spatial streams would provide better throughput.

When a small number of spatial streams was used in previous transmissions, the receiver may lack the information needed to estimate the throughput for a larger number of spatial streams. As such, under some circumstances the receiver may send, to the transmitter, as a suggested number of spatial streams, a number of spatial streams for which it is not able to estimate the throughput. For example, the receiver may determine that the following conditions were met during each of a number (e.g., a number between 2 and 100, e.g., 5) of consecutive previous transmissions received from the transmitter: (i) the number of spatial streams is smaller than the maximum supported number of spatial streams, (ii) the modulation and coding scheme is the maximum supported modulation and coding scheme, and (iii) the packet error rate is below the threshold. In response to making this determination, the receiver may send, to the transmitter, a suggested modulation and coding scheme lower than the one last used, and it may send to the transmitter, a suggested number of spatial streams greater than the one last used.

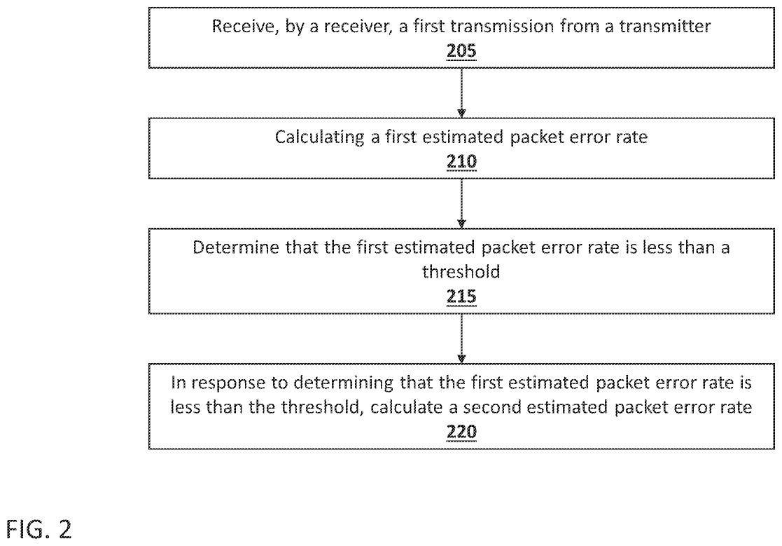

FIG. 2 shows a flowchart of a method, in some embodiments. The method includes, receiving, at 205, by a receiver, a first transmission from a transmitter; calculating, at 210, a first estimated packet error rate, for a first modulation and coding scheme and a first number of spatial streams, the first modulation and coding scheme having a first modulation and coding scheme index; determining, at 215, that the first estimated packet error rate is less than a threshold; and in response to determining that the first estimated packet error rate is less than the threshold, calculating, at 220, a second estimated packet error rate, for a second modulation and coding scheme and the first number of spatial streams, the second modulation and coding scheme having a second modulation and coding scheme index, the second modulation and coding scheme index being greater, by one, than the first modulation and coding scheme index.

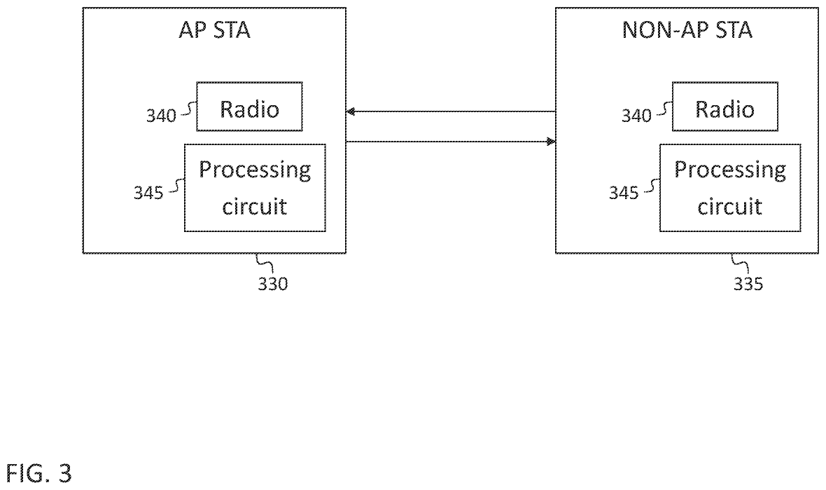

FIG. 3 shows a system including an AP STA 330 and a non-AP STA 335, in communication with each other. Each of the AP STA 330 and the non-AP STA 335 may include a respective radio 340 and a respective processing circuit (or a means for processing) 345, which may perform various methods disclosed herein, e.g., the processing circuit 345 of the non-AP STA 335 may perform (using the radio 340 of the non-AP STA 335) the method illustrated in FIG. 3. For example, the processing circuit 345 of the non-AP STA 335 may receive, via the radio 340 of the non-AP STA 335, transmissions from the AP STA 330, and the processing circuit 345 of the non-AP STA 335 may transmit, via the radio 340 of the non-AP STA 335, signals to the AP STA 330.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X-Y and the second quantity is at most X+Y. As used herein, when a second number is “within Y%” of a first number, it means that the second number is at least (1−Y/100) times the first number and the second number is at most (1+Y/100) times the first number. As used herein, the term “or” should be interpreted as “and/or”, such that, for example, “A or B” means any one of “A” or “B” or “A and B”.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity. Similarly, when an action is taken “in response to” an event or a circumstance, it means that the action is taken at least in part in response to the event or a circumstance (and that it may or may not be taken in response also to other events or circumstances).

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1−35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

Although exemplary embodiments of a system and method for feedback for link adaptation have been specifically described and illustrated herein, many modifications and variations will be apparent to those skilled in the art. Accordingly, it is to be understood that a system and method for feedback for link adaptation constructed according to principles of this disclosure may be embodied other than as specifically described herein. The invention is also defined in the following claims, and equivalents thereof.

What is claimed is:

1. A method, comprising:
receiving, by a receiver, a first transmission from a transmitter;
calculating a first estimated packet error rate, for a first modulation and coding scheme and a first number of spatial streams, the first modulation and coding scheme having a first modulation and coding scheme index;
determining that the first estimated packet error rate is less than a threshold; and
in response to determining that the first estimated packet error rate is less than the threshold, calculating a second estimated packet error rate, for a second modulation and coding scheme.

2. The method of claim 1, wherein the calculating of the second estimated packet error rate comprises further calculating the second estimated packet error rate for the first number of spatial streams.

3. The method of claim 2, wherein the second modulation and coding scheme has a second modulation and coding scheme index, the second modulation and coding scheme index being greater, by one, than the first modulation and coding scheme index.

4. The method of claim 3, further comprising calculating a first estimated throughput, for the first modulation and coding scheme and the first number of spatial streams.

5. The method of claim 4, wherein the first transmission is a transmission made using the first modulation and coding scheme and the first number of spatial streams.

6. The method of claim 4, further comprising:
determining that the second estimated packet error rate is less than the threshold; and,
in response to determining that the second estimated packet error rate is less than the threshold, calculating a second estimated throughput, for the second modulation and coding scheme and the first number of spatial streams.

7. The method of claim 6, further comprising:
determining that the second estimated throughput is greater than the first estimated throughput; and
in response to determining that the second estimated throughput is greater than the first estimated throughput, sending, by the receiver, to the transmitter, the second modulation and coding scheme as a suggested modulation and coding scheme.

8. The method of claim 4, further comprising:
determining that the second estimated packet error rate is greater than the threshold; and
in response to determining that the second estimated packet error rate is greater than the threshold, calculating a third estimated packet error rate for a third modulation and coding scheme and the first number of spatial streams, the third modulation and coding scheme having a third modulation and coding scheme index, the third modulation and coding scheme index being less, by one, than the first modulation and coding scheme index.

9. The method of claim 4, wherein the calculating of the first estimated throughput comprises calculating the first estimated throughput based on an assumption about a degradation in channel quality due to aging of channel state information.

10. The method of claim 3, further comprising:
receiving, by the receiver, a second transmission from the transmitter, the second transmission using a third modulation and coding scheme and the first number of spatial streams, the third modulation and coding scheme having a third modulation and coding scheme index;
calculating a third estimated packet error rate, for the third modulation and coding scheme and the first number of spatial streams;
determining that the third estimated packet error rate is greater than the threshold; and
in response to determining that the third estimated packet error rate is greater than the threshold, calculating a fourth estimated packet error rate, for a fourth modulation and coding scheme and the first number of spatial streams, the fourth modulation and coding scheme having a fourth modulation and coding scheme index, the fourth modulation and coding scheme index being less, by one, than the third modulation and coding scheme index.

11. The method of claim 3, further comprising:
receiving, by the receiver, a second transmission from the transmitter;
making a determination that, for each of the first transmission and the second transmission:
the number of spatial streams is less than the maximum supported number of spatial streams,
the modulation and coding scheme is the maximum supported modulation and coding scheme, and
the packet error rate is less than the threshold; and
in response to making the determination, sending, by the receiver, to the transmitter, a second number of spatial streams, higher than the first number of spatial streams, as a suggested number of spatial streams.

12. The method of claim 3, further comprising:
receiving, by the receiver, a second transmission from the transmitter;
determining that, for each of the first transmission and the second transmission, the packet error rate is greater than the threshold; and
in response to determining that, for each of the first transmission and the second transmission, the packet error rate is greater than the threshold, sending, by the receiver, to the transmitter, a third modulation and coding scheme as a suggested modulation and coding scheme, the third modulation and coding scheme having an index less than the first modulation and coding scheme index.

13. A system, comprising:
a processing circuit; and
memory, operatively connected to the processing circuit and storing instructions that, when executed by the processing circuit, cause the system to perform a method, the method comprising:
receiving a first transmission from a transmitter;
calculating a first estimated packet error rate, for a first modulation and coding scheme and a first number of spatial streams, the first modulation and coding scheme having a first modulation and coding scheme index;
determining that the first estimated packet error rate is less than a threshold; and
in response to determining that the first estimated packet error rate is less than the threshold, calculating a second estimated packet error rate, for a second modulation and coding scheme.

14. The system of claim 13, wherein:
the calculating of the second estimated packet error rate comprises further calculating the second estimated packet error rate for the first number of spatial streams; and
the second modulation and coding scheme has a second modulation and coding scheme index, the second modulation and coding scheme index being greater, by one, than the first modulation and coding scheme index.

15. The system of claim 14, wherein the method further comprises calculating a first estimated throughput, for the first modulation and coding scheme and the first number of spatial streams.

16. The system of claim 15, wherein the first transmission is a transmission made using the first modulation and coding scheme and the first number of spatial streams.

17. The system of claim 15, wherein the method further comprises:
determining that the second estimated packet error rate is less than the threshold; and,
in response to determining that the second estimated packet error rate is less than the threshold, calculating a second estimated throughput, for the second modulation and coding scheme and the first number of spatial streams.

18. The system of claim 17, wherein the method further comprises:
determining that the second estimated throughput is greater than the first estimated throughput; and
in response to determining that the second estimated throughput is greater than the first estimated throughput, sending, to the transmitter, the second modulation and coding scheme as a suggested modulation and coding scheme.

19. The system of claim 15, wherein the method further comprises:
determining that the second estimated packet error rate is greater than the threshold; and
in response to determining that the second estimated packet error rate is greater than the threshold, calculating a third estimated packet error rate for a third modulation and coding scheme and the first number of spatial streams, the third modulation and coding scheme having a third modulation and coding scheme index, the third modulation and coding scheme index being less, by one, than the first modulation and coding scheme index.

20. The system of claim 14, wherein the method further comprises:
receiving a second transmission from the transmitter, the second transmission using a third modulation and coding scheme and the first number of spatial streams, the third modulation and coding scheme having a third modulation and coding scheme index;
calculating a third estimated packet error rate, for the third modulation and coding scheme and the first number of spatial streams;
determining that the third estimated packet error rate is greater than the threshold; and
in response to determining that the third estimated packet error rate is greater than the threshold, calculating a fourth estimated packet error rate, for a fourth modulation and coding scheme and the first number of spatial streams, the fourth modulation and coding scheme having a fourth modulation and coding scheme index, the fourth modulation and coding scheme index being less, by one, than the third modulation and coding scheme index.

21. The system of claim 14, wherein the method further comprises:
receiving a second transmission from the transmitter;
making a determination that, for each of the first transmission and the second transmission:
the number of spatial streams is less than the maximum supported number of spatial streams,
the modulation and coding scheme is the maximum supported modulation and coding scheme, and
the packet error rate is less than the threshold; and
in response to making the determination, sending, to the transmitter, a second number of spatial streams, higher than the first number of spatial streams, as a suggested number of spatial streams.

22. The system of claim 14, wherein the method further comprises:
receiving a second transmission from the transmitter;
determining that, for each of the first transmission and the second transmission, the packet error rate is greater than the threshold; and
in response to determining that, for each of the first transmission and the second transmission, the packet error rate is greater than the threshold, sending, to the transmitter, a third modulation and coding scheme as a suggested modulation and coding scheme, the third modulation and coding scheme having an index less than the first modulation and coding scheme index.

23. A system, comprising:
means for processing; and
memory, operatively connected to the means for processing and storing instructions that, when executed by the means for processing, cause the system to perform a method, the method comprising:
receiving a first transmission from a transmitter;
calculating a first estimated packet error rate, for a first modulation and coding scheme and a first number of spatial streams, the first modulation and coding scheme having a first modulation and coding scheme index;
determining that the first estimated packet error rate is less than a threshold; and
in response to determining that the first estimated packet error rate is less than the threshold, calculating a second estimated packet error rate, for a second modulation and coding scheme and the first number of spatial streams.
